(19) United States
(12) Patent Application Publication
(10) Pub. No.: US 2009/0111959 A1
(43) Pub. Date: Apr. 30, 2009

(54) High silica DDR-type molecular sieve, its synthesis and use

(76) Inventors: Guang Cao, Branchburg, NJ (US); Machteld Maria Mertens, Boortmeerbeek (BE); Karl G. Strohmaier, Port Murray, NJ (US); Hailian Li, Fremont, CA (US); Robert J. Saxton, Pleasanton, CA (US); Anil S. Guram, San Jose, CA (US); Jeffrey C. Yoder, San Jose, CA (US); Mark T. Muraoka, Mountain View, CA (US); Anthony F. Volpe, JR., Santa Clara, CA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/599,231

(22) Filed: Nov. 14, 2006

Related U.S. Application Data
(60) Provisional application No. 60/737,154, filed on Nov. 16, 2005.

(51) Int. Cl. C08F 4/12; B01J 29/04; B01D 53/62; B01J 29/06

(52) U.S. Cl. 526/226; 502/60; 502/62; 423/230

(57) ABSTRACT

A crystalline material has a DDR framework type and, in its calcined, anhydrous form, has a composition involving the molar relationship:

(n)X₂O₃:YO₂,

wherein X is a trivalent element, Y is a tetravalent element and n is from 0 to less than 0.01 and wherein the crystals of said material have an average diameter less than or equal to 2 microns. The material is synthesized in the presence of an N-ethyltropanium compound as directing agent.

### CROSS-REFERENCE TO RELATED APPLICATIONS

This application claims priority to application Ser. No. 60/737,154, filed Nov. 16, 2005, which is hereby incorporated by reference.

### FIELD OF THE INVENTION

This invention relates to a high silica DDR framework-type molecular sieve, its synthesis and its use in sorptive separation, for example of methane from carbon dioxide, and as a catalyst in organic conversion reactions, such as the conversion of oxygenates, particularly methanol, to olefins, particularly ethylene and propylene.

### BACKGROUND OF THE INVENTION

Molecular sieves are classified by the Structure Commission of the International Zeolite Association according to the rules of the IUPAC Commission on Zeolite Nomenclature. According to this classification, framework-type zeolites and other crystalline microporous molecular sieves, for which a structure has been established, are assigned a three letter code and are described in the Atlas of Zeolite Framework Types, 5th edition, Elsevier, London, England (2001). Deca-dodecasil 3R is one of the molecular sieves for which a structure has been established and materials of this framework type are designated as DDR. One example of a DDR framework-type molecular sieve is ZSM-58.

DDR framework-type molecular sieves have pores which are defined by parallel channels formed by 8-membered rings of tetrahedrally coordinated atoms and which have cross sectional dimensions of 3.6′ by 4.4′. DDR framework-type zeolites are, therefore, potentially useful in catalyzing chemical reactions, including the conversion of oxygenates to olefins (OTO), where small pore size is desirable.

Current understanding of the OTO reactions suggests a complex sequence in which three major steps can be identified: (1) an induction period leading to the formation of an active carbon pool (alkyl-aromatics), (2) alkylation-dealkylation reactions of these active intermediates leading to products, and (3) a gradual build-up of condensed ring aromatics. OTO is, therefore, an inherently transient chemical transformation in which the catalyst is in a continuous state of change. The ability of the catalyst to maintain high olefin yields for prolonged periods of time relies on a delicate balance between the relative rates at which the above processes take place. The formation of coke-like molecules is of singular importance because their accumulation interferes with the desired reaction sequence in a number of ways. In particular, coke renders the carbon pool inactive, lowers the rates of diffusion of reactants and products, increases the potential for undesired secondary reactions and limits catalyst life.

Over the last two decades, many catalytic materials have been identified as being useful for carrying out the OTO reactions. Crystalline molecular sieves are the preferred catalysts today because they simultaneously address the acidity and morphological requirements for the reactions. Particularly preferred materials are eight-membered ring aluminosilicates and silicoaluminophosphates. One key requirement to the use of aluminosilicates in OTO reactions appears to be ensuring a relatively high silica to alumina molar ratio, preferably greater than 100. Another important factor is reducing crystal size, since this improves the diffusional characteristics of the catalyst.

Although DDR framework-type zeolites have been proposed for use in OTO reactions, see, for example, U.S. Pat. No. 6,872,680, with currently synthesized materials, a high silica content and small crystal size are two attributes that have been mutually exclusive in DDR framework molecular sieves. Thus, as disclosed in Microporous and Mesoporous Materials, Vol. 83, pp. 345-356, (2005), whereas ZSM-58 readily forms crystals with an average size below 1 micron at silica to alumina molar ratios below 50, as the silica to alumina molar ratio increases towards 100 the crystals tend to increase in size to about 1 to 12 microns and typically have a size of between 3 and 15 microns when the silica to alumina molar ratio is as high as 1000.

According to the invention, it has now been found that a DDR framework-type material having both a high silica to alumina molar ratio (even a crystalline silicate) and a small crystal size can be produced using a directing agent containing the N-ethyl-tropanium cation.

U.S. Pat. No. 4,698,217 discloses a crystalline silicate designated as ZSM-58 and its synthesis in the presence of methyltropinium cations as the organic directing agent. ZSM-58 is described as having a silica/alumina molar ratio of 50 to 1000 and the Examples disclose synthesis of the material with silica/alumina molar ratios varying between 62 and 223.

U.S. Pat. No. 5,200,377 discloses the synthesis of a crystalline zeolite SSZ-28 using an N,N-dimethyl-tropinium or N,N-dimethyl-3-azonium bicyclo[3.2.2]nonane cation as the directing agent. SSZ-28 is said to have the same X-ray diffraction pattern as ZSM-58 but a higher aluminum content, such that its silica/alumina molar ratios varies between 20 and 45.

U.S. Pat. No. 5,273,736 discloses the synthesis of a variety of crystalline molecular sieves, particularly large pore zeolites, using an organocation templating agent derived from a 9-azabicyclo[3.3.1]nonane and having the formula:

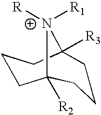

where R, R₁, R₂, and R₃ are each selected from the group consisting of hydrogen and a lower branched or straight chain alkyl, preferably of from 1 to about 10 carbon atoms. In particular, Examples 2 to 4 of the '736 patent disclose synthesis of SSZ-35 in the presence of N-ethyl-N-methyl-9-azoniabicyclo[3.3.1 ]nonane hydroxide. SSZ-35 is an STF framework-type molecular sieve with pores having cross sectional dimensions of 5.4′ by 5.7′.

U.S. Pat. No. 5,958,370 discloses the synthesis of an AEI framework-type zeolite, designated as SSZ-39, in the presence of certain cyclic or polycyclic quaternary ammonium cation templating agents, including N,N-dimethyl-9-azoniabicyclo [3.3.1]nonane.

In an article entitled “Guest/Host Relationships in the Synthesis of the Novel Cage-Based Zeolites SSZ-35, SSZ-36 and SSZ-39”, J. Am. Chem. Soc. 2000, Vol.122, pp. 263-273, Wagner et al. report the synthesis of three high silica molecular sieves, SSZ-35, SSZ-36 and SSZ-39, from a variety of cyclic and polycyclic quaternized amine molecules as structure directing agents. In particular, Table 4, Entry 12 of this article indicates that with the directing agent:

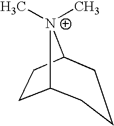

a CHA framework-type molecular sieve is produced with a synthesis mixture having a silica/alumina molar ratio 30, a mixture of CHA and DDR framework-type molecular sieves is produced with a synthesis mixture having a silica/alumina molar ratio 70 and a DDR framework-type molecular sieve is produced with a synthesis mixture having a silica/alumina molar ratio greater than 300.

### SUMMARY OF THE INVENTION

In one aspect, the invention resides in a crystalline material having a DDR framework type, wherein said material, in its calcined, anhydrous form, has a composition involving the molar relationship:

(n)X₂O₃:YO₂,

wherein X is a trivalent element, Y is a tetravalent element and n is from 0 to less than 0.01 and wherein the crystals of said material have an average diameter less than or equal to 2 microns.

Conveniently, said crystalline material, in its calcined form, contains from about 1 to about 100 ppm, such as from about 5 to about 50 ppm, for example, from about 10 to about 20 ppm, by weight of a halide. Typically said halide comprises fluoride.

Conveniently, the crystals of said material have an average diameter of about 1 to 1.5 microns.

In a further aspect, the invention resides in a crystalline material having a DDR framework type, wherein said material, in its as-synthesized form, has a composition involving the molar relationship:

(n)X₂O₃ :YO₂:(m)R:(x)F:zH₂O,

wherein X is a trivalent element, Y is a tetravalent element, n is from 0 to less than 0.01, m is from about 0.01 to about 2, such as from about 0.1 to about 1, x is from about 0 to about 2, such as from about 0.01 to about 1, z is from about 0.5 to about 100, such as from about 2 to about 20, and R is at least one organic cation having the formula:

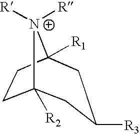

wherein one of R′ and R″ is methyl and the other R′ and R″ is ethyl, R₁ and R₂ are each independently hydrogen or C₁ to C₁₀ alkyl, and R₃ is hydrogen, hydroxyl or C₁ to C₁₀ alkyl.

In yet a further aspect, the invention resides in a method of synthesizing a crystalline material having a DDR framework-type, the method comprising:

a) forming a reaction mixture capable of forming said crystalline material having a DDR framework-type, wherein the reaction mixture comprises an organic directing agent having the formula:

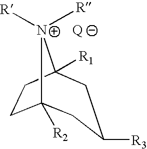

wherein one of R′ and R″ is methyl and the other R′ and R″ is ethyl, R₁ and R₂ are each independently hydrogen or C₁ to C₁₀ alkyl and R₃ is hydrogen, hydroxyl or C₁ to C₁₀ alkyl; and Q⁻ is an anion.

b) recovering from said reaction mixture said crystalline material comprising a DDR framework-type.

Preferably, each of R₁, R₂ and R₃ is hydrogen.

In still yet a further aspect, the invention resides in a method of synthesizing a crystalline material having a DDR framework-type and having, in its calcined and anhydrous form, a composition involving the molar relationship:

(n)X₂O₃:YO₂,

wherein X is a trivalent element; Y is a tetravalent element, and n is from 0 to less than 0.01, the method comprising:

(a) preparing a reaction mixture capable of forming said crystalline material having a DDR framework-type, said reaction mixture comprising a source of water, a source of an oxide of the tetravalent element Y, optionally, a source of an oxide of the trivalent element X, an organic directing agent for directing the formation of said crystalline material and having the formula:

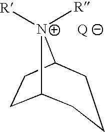

wherein one of R′ and R″ is methyl and the other R′ and R″ is ethyl and Q⁻ is an anion;

(b) maintaining said reaction mixture under conditions sufficient to form crystals of said crystalline material having a DDR framework-type; and

(c) recovering said crystalline material from (b).

In one embodiment, said reaction mixture also comprises a halide or a halide-containing compound, such as a fluoride or a fluoride-containing compound.

The invention further resides in the use of the DDR framework-type molecular sieve described herein in the conversion of oxygenates, such as methanol, to olefins, particularly ethylene and propylene, and in the sorptive separation of gases, for example, of methane from carbon dioxide.

### BRIEF DESCRIPTION OF THE DRAWINGS

FIG. 1 is an X-ray diffraction pattern of the as-synthesized product of Example 1.

FIG. 2 is an SEM picture of the product of Example 1.

FIG. 3 is an SEM picture of the product of Example 2.

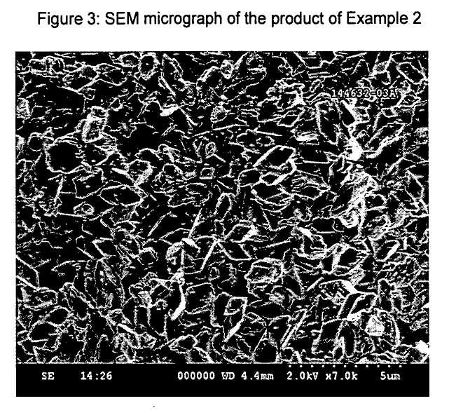

### DETAILED DESCRIPTION OF THE EMBODIMENTS

The present invention relates to a high silica zeolite having a DDR framework type and a small crystal size, i.e., with an average diameter less than or equal to 2 microns, and to its synthesis using a directing agent containing the N-ethyl-tropanium cation. In addition, the invention relates to the use of this material as a catalyst in organic conversion processes, such as the conversion of oxygenates to olefins, and as a sorbent, such as in the sorptive separation of methane from carbon dioxide.

### DDR Framework-Type Molecular Sieve

In its as-synthesized form, the high silica DDR-type molecular sieve, of the present invention has an X-ray diffraction pattern having the characteristic lines shown in Table 1 below:

TABLE 1

| | Relative Intensities |
|---|---|
| d(A) | 100 I/Io |
| 11.25 | 17 |
| 10.14 | 3 |
| 7.66 | 15 |
| 6.82 | 9 |
| 6.74 | 12 |
| 6.10 | 10 |
| 5.68 | 66 |
| 5.20 | 9 |
| 5.12 | 100 |
| 4.82 | 33 |
| 4.79 | 21 |
| 4.66 | 37 |
| 4.46 | 52 |
| 4.39 | 3 |
| 4.11 | 29 |
| 3.97 | 13 |
| 3.93 | 7 |
| 3.84 | 8 |
| 3.81 | 25 |
| 3.77 | 17 |
| 3.56 | 10 |
| 3.44 | 19 |
| 3.37 | 48 |
| 3.33 | 49 |
| 3.29 | 38 |
| 3.14 | 13 |
| 3.06 | 9 |
| 3.04 | 15 |
| 3.02 | 10 |
| 2.99 | 13 |
| 2.86 | 3 |
| 2.83 | 3 |
| 2.73 | 2 |
| 2.65 | 4 |
| 2.58 | 2 |

These X-ray diffraction data were collected with a Philips powder X-Ray Diffractometer, equipped with a scintillation detector with graphite monochromator, using copper K-alpha radiation. The diffraction data were recorded by step-scanning at 0.02 degrees of two-theta, where theta is the Bragg angle, and a counting time of 1 second for each step. The interplanar spacing, d's, were calculated in Angstrom units, and the relative intensities of the lines, (where I/Iₒ is one-hundredth of the intensity of the strongest line), above background were determined by integrating the peak intensities. It should be understood that diffraction data listed for this sample as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework atom connectivities. These minor effects, including changes in relative intensities, can also occur as a result of differences in cation content, framework composition, nature and degree of pore filling, crystal size and shape, preferred orientation and thermal and/or hydrothermal history.

In its calcined, anhydrous form, the DDR framework-type material of the invention is preferably substantially free of framework phosphorus and has a composition involving the molar relationship:

(n)X₂O₃:YO₂,

wherein X (if present) is a trivalent element, such as aluminum, boron, iron, indium, gallium or a combination thereof, typically aluminum; Y is a tetravalent element, such as silicon, tin, titanium, germanium, or a combination thereof, typically silicon; and n is from 0 to about 0.1, for example, from 0 to about 0.01, such as from about 0.0005 to about 0.007 and wherein the crystals of said material have an average diameter less than or equal to 2 microns.

In its as-synthesized form, the crystalline material produced by the method of the present invention has a composition involving the molar relationship:

(n)X₂O₃:YO₂:(m)R:(x)F:z H₂O,

wherein X, Y, and n are as defined in the preceding paragraph; m ranges from about 0.01 to about 2, such as from about 0.1 to about 1; x ranges from about 0 to about 2, such as from about 0.01 to about 1; z ranges from about 0.5 to about 100, such as from about 2 to about 20 and R is at least one organic cation having the formula:

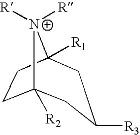

wherein one of R′ and R″ is methyl and the other R′ and R″ is ethyl, R₁ and R₂ are each independently hydrogen or C₁ to C₁₀ alkyl and R₃ is hydrogen, hydroxyl or C₁ to C₁₀ alkyl. In one embodiment, R′ is ethyl and R″ is methyl. Preferably, each of R₁, R₂ and R₃ is hydrogen.

The R and F components, which are associated with the as-synthesized material as a result of their presence during crystallization, are at least partly removed by post-crystallization methods hereinafter more particularly described. Typically, the as-synthesized DDR framework-type crystalline material of the present invention contains only low levels of alkali metal, generally such that the combined amount of any potassium and sodium is less than 50% of the X₂O₃ on a molar basis. For this reason, after removal of the organic directing agent (R), the material generally exhibits catalytic activity without a preliminary ion-exchange step to remove alkali metal cations.

To the extent desired and depending on the X₂O₃/YO₂ molar ratio of the material, any cations in the as-synthesized DDR framework-type material can be replaced in accordance with techniques well known in the art, at least in part, by ion exchange with other cations. Preferred replacing cations include metal ions, hydrogen ions, hydrogen precursor, e.g., ammonium ions, and mixtures thereof. Particularly preferred cations are those which tailor the catalytic activity for certain hydrocarbon conversion reactions. These include hydrogen, rare earth metals and metals of Groups IIA, IIIA, IVA, VA, IB, IIB, IIIB, IVB, VB, VIB, VIIB, and VIII of the Periodic Table of the Elements.

### Synthesis of DDR Framework-Type Molecular Sieve

The crystalline material of the invention can be prepared from a reaction mixture containing a source of water, a source of an oxide of the tetravalent element Y, optionally a source of an oxide of the trivalent element X, a source of said organic cation (R) as described above, and, optionally, a halide or a halide-containing compound, such as a fluoride or a fluoride-containing compound, said reaction mixture having a composition, in terms of mole ratios of oxides, within the following ranges:

| Reactants | Useful | Typical |
|---|---|---|
| H₂O/YO₂ | 2 to 15 | 4 to 10 |
| Halide/YO₂ | 0.1 to 1.0 | 0.3 to 0.6 |
| R/YO₂ | 0.1 to 1.0 | 0.3 to 0.6 |
| X₂O₃/YO₂ | 0 to 0.02 | 0 to 0.01 |

Where the tetravalent element Y is silicon, suitable sources of silicon include silicates, e.g., tetraalkyl orthosilicates, fumed silica, such as Aerosil (available from Degussa), and aqueous colloidal suspensions of silica, for example, that sold by E.I. du Pont de Nemours under the tradename Ludox. Where the trivalent element X is aluminum, suitable sources of aluminum include aluminum salts, especially water-soluble salts, such as aluminum nitrate, as well as hydrated aluminum oxides, such as boehmite and pseudoboehmite. Where the halide is fluoride, suitable sources of fluoride include hydrogen fluoride, although more benign sources of fluoride such as alkali metal fluorides and fluoride salts of the organic directing agent are preferred.

The organic directing agent R used herein typically comprises the N-ethyltropanium cation and a suitable anion, such as hydroxide or halide. N-ethyltropanium hydroxide is conveniently synthesized by alkylation of tropane (8-methyl-8-azabicyclo [3.2.1]octane, available from Aldrich) with ethyliodide, followed by anion exchange with OH— exchange resin.

Typically, the reaction mixture also contains seeds to facilitate the crystallization process. The amount of seeds employed can vary widely, but generally the reaction mixture comprises from about 0.1 ppm by weight to about 10,000 ppm by weight, such as from about 100 ppm by weight to about 5,000 by weight, of said seeds. Conveniently, the seeds comprise a crystalline material having an AEI, DDR, LEV, CHA, ERI, AFX, or OFF framework-type molecular sieve. The seeds may be added to the reaction mixture as a colloidal suspension in a liquid medium, such as water. The production of colloidal seed suspensions and their use in the synthesis of molecular sieves are disclosed in, for example, International Publication Nos. WO 00/06493 and WO 00/06494 published on Feb. 10, 2000, and incorporated herein by reference.

Conveniently, the reaction mixture has a pH of about 4 to about 14, such as about 5 to about 13, for example, about 6 to about 12.

Crystallization can be carried out at either static or stirred conditions in a suitable reactor vessel, such as, for example, polypropylene jars or Teflon®-lined or stainless steel autoclaves, at a temperature of about 120° C. to about 220° C., such as about 140° C. to about 200° C., for a time sufficient for crystallization to occur. Formation of the crystalline product can take anywhere from around 30 minutes up to as much as 2 weeks, such as from about 45 minutes to about 240 hours, for example, from about 1.0 to about 120 hours. The duration depends on the temperature employed, with higher temperatures typically requiring shorter hydrothermal treatments.

Typically, the crystalline product is formed in solution and can be recovered by standard means, such as by centrifugation or filtration. The separated product can also be washed, recovered by centrifugation or filtration and dried. The resultant product is found to comprise particles with an average crystal size below 2 microns and typically about 1 to 1.5 microns (e.g., which was determined herein through a numerical average of crystal sizes as viewed in a scanning electron microscope).

As a result of the crystallization process, the recovered crystalline product contains within its pores at least a portion of the organic directing agent used in the synthesis. In a preferred embodiment, activation is performed in such a manner that the organic directing agent is removed from the molecular sieve, leaving active catalytic sites within the microporous channels of the molecular sieve open for contact with a feedstock. The activation process is typically accomplished by calcining, or essentially heating the molecular sieve comprising the template at a temperature of from about 200° C. to about 800° C. in the presence of an oxygen-containing gas. In some cases, it may be desirable to heat the molecular sieve in an environment having a low or zero oxygen concentration. This type of process can be used for partial or complete removal of the organic directing agent from the intracrystalline pore system. In other cases, particularly with smaller organic directing agents, complete or partial removal from the sieve can be accomplished by conventional desorption processes.

Once the DDR framework-type containing material of the invention has been synthesized, it can be formulated into a catalyst composition by combination with other materials, such as binders and/or matrix materials that provide additional hardness or catalytic activity to the finished catalyst.

Materials which can be blended with the DDR framework-type containing material of the invention can be various inert or catalytically active materials. These materials include compositions such as kaolin and other clays, various forms of rare earth metals, other non-zeolite catalyst components, zeolite catalyst components, alumina or alumina sol, titania, zirconia, quartz, silica or silica sol, and mixtures thereof. These components are also effective in reducing overall catalyst cost, acting as a thermal sink to assist in heat shielding the catalyst during regeneration, densifying the catalyst and increasing catalyst strength. When blended with such components, the amount of zeolitic material contained in the final catalyst product ranges from 10 to 90 weight percent of the total catalyst, preferably 20 to 70 weight percent of the total catalyst.

### Uses of DDR Framework-Type Molecular Sieve

The crystalline material of the invention can be used to dry gases and liquids; for selective molecular separation based on size and polar properties; as an ion-exchanger; as a chemical carrier; in gas chromatography; and as a catalyst in organic conversion reactions.

One example of the use of the DDR framework material of the invention in selective molecular separation is in the separation of methane from carbon dioxide. This typically involves passing a gaseous mixture containing methane and carbon dioxide, such as natural gas, though a mixed matrix membrane comprising a continuous organic polymer phase having dispersed therein particles of the DDR framework material. The size of the pores of the DDR framework material are such that they readily permit the passage of carbon dioxide, but only permit the passage of methane at a significantly slower rate.

The preferred membranes are made from polymer materials that will pass carbon dioxide (and nitrogen) preferentially over methane and other light hydrocarbons. Such polymers are well known in the art and are described, for example, in U.S. Pat. No. 4,230,463 to Monsanto and U.S. Pat. No. 3,567,632 to DuPont. Suitable membrane materials include polyimides, polysulfones, and cellulosic polymers.

Preferably, the polymer is a rigid, glassy polymer as opposed to a rubbery polymer or a flexible glassy polymer. Glassy polymers are differentiated from rubbery polymers by the rate of segmental movement of polymer chains. Polymers in the glassy state do not have the rapid molecular motions that permit rubbery polymers their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (T_{g}) is the dividing point between the rubbery or glassy state. Above the T_{g}, the polymer exists in the rubbery state; below the T_{g}, the polymer exists in the glassy state. Generally, glassy polymers provide a selective environment for gas diffusion and are favored for gas separation applications. Rigid, glassy polymers describe polymers with rigid polymer chain backbones that have limited intramolecular rotational mobility and are often characterized by having high glass transition temperatures (T_{g}>150° C.).

Examples of suitable polymers include substituted or unsubstituted polymers and may be selected from polysulfones; poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate-butyrate, cellulose propionate, ethyl cellulose, methyl cellulose, nitrocellulose, etc.; polyamides and polyimides, including aryl polyamides and aryl polyimides; polyethers; polyetherimides; polyetherketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polypyrrolones; polysulfides; polymers from monomers having alpha-olefinic unsaturation other than mentioned above such as poly (ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly (benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acyl groups and the like. It is preferred that the membranes exhibit a carbon dioxide/methane selectivity of at least about 10, more preferably at least about 20, and most preferably at least about 30.

The mixed matrix membrane is typically formed by casting an homogeneous slurry containing particles of the DDR framework material and the desired polymer. The slurry can be mixed, for example, using homogenizers and/or ultrasound to maximize the dispersion of the particles in the polymer or polymer solution. In addition, it may be desirable to enhance the compatability of the molecular sieve and the polymer matrix by adding a small amount of the desired matrix polymer or any suitable “sizing agent” to a dispersion of the molecular sieve in a suitable solvent to produce an initial thin coating (i.e., boundary layer) of the polymer or sizing agent on the molecular sieve surface. After casting the membrane, the solvent is slowly evaporated to form a solid membrane film, the film is dried and can then be annealed by heating above its glass transition temperature.

Gas purification, for example, separation of methane from carbon dioxide, is typically effected by passage of the gas mixture through the membrane at a temperature between about 25° C. and 200° C. and a pressure of between about 50 psia and 5,000 psia (345 kPa and 34,500 kPa).

Examples of suitable catalytic uses of the crystalline DDR framework-type material of the invention include (a) hydrocracking of heavy petroleum residual feedstocks, cyclic stocks and other hydrocrackate charge stocks, normally in the presence of a hydrogenation component iselected from Groups 6 and 8 to 10 of the Periodic Table of Elements; (b) dewaxing, including isomerization dewaxing, to selectively remove straight chain paraffins from hydrocarbon feedstocks typically boiling above 177° C., including raffinates and lubricating oil basestocks; (c) catalytic cracking of hydrocarbon feedstocks, such as naphthas, gas oils and residual oils, normally in the presence of a large pore cracking catalyst, such as zeolite Y; (d) oligomerization of straight and branched chain olefins having from about 2 to 21, preferably 2 to 5 carbon atoms, to produce medium to heavy olefins which are useful for both fuels, i.e., gasoline or a gasoline blending stock, and chemicals; (e) isomerization of olefins, particularly olefins having 4 to 6 carbon atoms, and especially normal butene to produce iso-olefins; (f) upgrading of lower alkanes, such as methane, to higher hydrocarbons, such as ethylene and benzene; (g) disproportionation of alkylaromatic hydrocarbons, such as toluene, to produce dialkylaromatic hydrocarbons, such as xylenes; (h) alkylation of aromatic hydrocarbons, such as benzene, with olefins, such as ethylene and propylene, to produce ethylbenzene and cumene; (i) isomerization of dialkylaromatic hydrocarbons, such as xylenes, (j) catalytic reduction of nitrogen oxides, and (k) synthesis of monoalkylamines and dialkylamines.

In particular, the crystalline DDR framework-type material of the invention is useful in the catalytic conversion of oxygenates to one or more olefins, particularly ethylene and propylene. As used herein, the term “oxygenates” is defined to include, but is not necessarily limited to aliphatic alcohols, ethers, carbonyl compounds (aldehydes, ketones, carboxylic acids, carbonates, and the like), and also compounds containing hetero-atoms, such as, halides, mercaptans, sulfides, amines, and mixtures thereof. The aliphatic moiety will normally contain from about 1 to about 10 carbon atoms, such as from about 1 to about 4 carbon atoms.

Representative oxygenates include lower straight chain or branched aliphatic alcohols, their unsaturated counterparts, and their nitrogen, halogen and sulfur analogues. Examples of suitable oxygenate compounds include methanol; ethanol; n-propanol; isopropanol; C₄-C₁₀ alcohols; methyl ethyl ether; dimethyl ether; diethyl ether; di-isopropyl ether; methyl mercaptan; methyl sulfide; methyl amine; ethyl mercaptan; di-ethyl sulfide; di-ethyl amine; ethyl chloride; formaldehyde; di-methyl carbonate; di-methyl ketone; acetic acid; n-alkyl amines, n-alkyl halides, n-alkyl sulfides having n-alkyl groups of comprising the range of from about 3 to about 10 carbon atoms; and mixtures thereof. Particularly suitable oxygenate compounds are methanol, dimethyl ether, or mixtures thereof, most preferably methanol. As used herein, the term “oxygenate” designates only the organic material used as the feed. The total charge of feed to the reaction zone may contain additional compounds, such as diluents.

In the present oxygenate conversion process, a feedstock comprising an organic oxygenate, optionally, with one or more diluents, is contacted in the vapor phase in a reaction zone with a catalyst comprising the molecular sieve of the present invention at effective process conditions so as to produce the desired olefins. Alternatively, the process may be carried out in a liquid or a mixed vapor/liquid phase. When the process is carried out in the liquid phase or a mixed vapor/liquid phase, different conversion rates and selectivities of feedstock-to-product may result depending upon the catalyst and the reaction conditions.

When present, the diluent(s) is generally non-reactive to the feedstock or molecular sieve catalyst composition and is typically used to reduce the concentration of the oxygenate in the feedstock. Non-limiting examples of suitable diluents include helium, argon, nitrogen, carbon monoxide, carbon dioxide, water, essentially non-reactive paraffins (especially alkanes such as methane, ethane, and propane), essentially non-reactive aromatic compounds, and mixtures thereof. The most preferred diluents are water and nitrogen, with water being particularly preferred. Diluent(s) may comprise from about 1 mol % to about 99 mol % of the total feed mixture.

The temperature employed in the oxygenate conversion process may vary over a wide range, such as from about 200° C. to about 1000° C., for example, from about 250° C. to about 800° C., including from about 250° C. to about 750° C., conveniently from about 300° C. to about 650° C., typically from about 350° C. to about 600° C., and particularly from about 400° C. to about 600° C.

Light olefin products will form, although not necessarily in optimum amounts, at a wide range of pressures, including but not limited to autogenous pressures and pressures in the range of from about 0.1 kPa to about 10 MPa. Conveniently, the pressure is in the range of from about 7 kPa to about 5 MPa, such as in the range of from about 50 kPa to about 1 MPa. The foregoing pressures are exclusive of diluent, if any is present, and refer to the partial pressure of the feedstock as it relates to oxygenate compounds and/or mixtures thereof. Lower and upper extremes of pressure may adversely affect selectivity, conversion, coking rate, and/or reaction rate; however, light olefins such as ethylene still may form.

The process should be continued for a period of time sufficient to produce the desired olefin products. The reaction time may vary from tenths of seconds to a number of hours. The reaction time is largely determined by the reaction temperature, the pressure, the catalyst selected, the weight hourly space velocity, the phase (liquid or vapor) and the selected process design characteristics.

A wide range of weight hourly space velocities (WHSV) for the feedstock will function in the present process. WHSV is defined as weight of feed (excluding diluent) per hour per weight of a total reaction volume of molecular sieve catalyst (excluding inerts and/or fillers). The WHSV generally should be in the range of from about 0.01 hr⁻¹ to about 500 hr⁻¹, such as in the range of from about 0.5 hr⁻¹ to about 300 hr⁻¹, for example, in the range of from about 0.1 hr⁻¹ to about 200 hr⁻¹.

A practical embodiment of a reactor system for the oxygenate conversion process is a circulating fluid-bed reactor with continuous regeneration, similar to a modem fluid catalytic cracker. Fixed beds are generally not preferred for the process because oxygenate to olefin conversion is a highly exothermic process which requires several stages with intercoolers or other cooling devices. The reaction also results in a high pressure drop due to the production of low pressure, low density gas.

Because the catalyst must be regenerated frequently, the reactor should allow easy removal of a portion of the catalyst to a regenerator, where the catalyst is subjected to a regeneration medium, such as a gas comprising oxygen, for example, air, to bum off coke from the catalyst, which restores the catalyst activity. The conditions of temperature, oxygen partial pressure, and residence time in the regenerator should be selected to achieve a coke content on regenerated catalyst of less than about 0.5 wt %. At least a portion of the regenerated catalyst should be returned to the reactor.

In one embodiment, the catalyst is pretreated with dimethyl ether, a C₂-C₄ aldehyde composition and/or a C₄-C₇ olefin composition to form an integrated hydrocarbon co-catalyst within the porous framework of the DDR framework-type molecular sieve prior to the catalyst being used to convert oxygenate to olefins. Desirably, the pretreatment is conducted at a temperature of at least 10° C., such as at least 25° C., for example, at least 50° C., higher than the temperature used for the oxygenate reaction zone and is arranged to produce at least 0.1 wt %, such as at least 1 wt %, for example, at least about 5 wt % of the integrated hydrocarbon co-catalyst, based on total weight of the molecular sieve. Such preliminary treating to increase the carbon content of the molecular sieve is known as “pre-pooling” and is further described in U.S. application Ser. Nos. 10/712,668, 10/712,952 and 10/712,953 all of which were filed Nov. 12, 2003, and are incorporated herein by reference.

The invention will now be more particularly described with reference to the following Examples and the accompanying drawings.

In the Examples, X-ray Powder Diffractograms were recorded on a Siemens D500 diffractometer with voltage of 40 kV and current of 30 mA, using a Cu target and Ni-filter (A=0.154 nm). Elemental analysis of Al, Si, and P was performed using the Inductively Coupled Plasma (ICP) spectroscopy.

### EXAMPLE 1

A 92.81 mg/ml aqueous solution of Al₂(SO₄)₃·18H₂O(0.161 ml) was added to an aqueous solution of N-ethyl-tropanium hydroxide (ETA*OH—) (5.216 ml, 0.4298M) followed by addition of tetraethylorthosilicate (1.000ml). The resultant mixture was sealed and continuously stirred for 18 hours (over night) at room temperature until all tetraethylorthosilicate was completely hydrolyzed. To this clear solution was added 48 wt % aqueous solution of hydrofluoric acid (0.098 ml) which immediately resulted in a mixture slurry. This mixture slurry was further homogenized by stirring and exposed to air for evaporation of water and ethanol until a thick slurry mixture was obtained. To this slurry was added with mechanical mixing 0.035 ml (0.46 wt % based on dry gel solid) of LEV colloidal seeds (14.1 wt. %). Extra water was further evaporated under static conditions to give 1078 mg of a dry gel solid having the composition:

SiO₂:0.005Al₂O₃:0.5ETA:0.6F:5.0H₂O

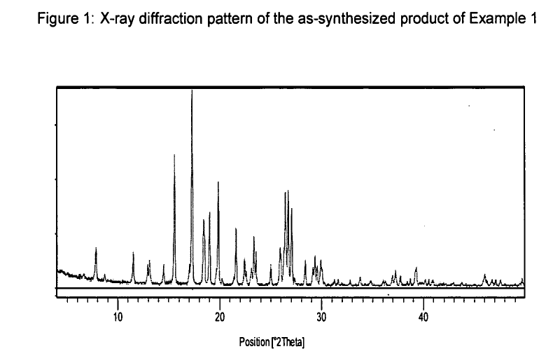

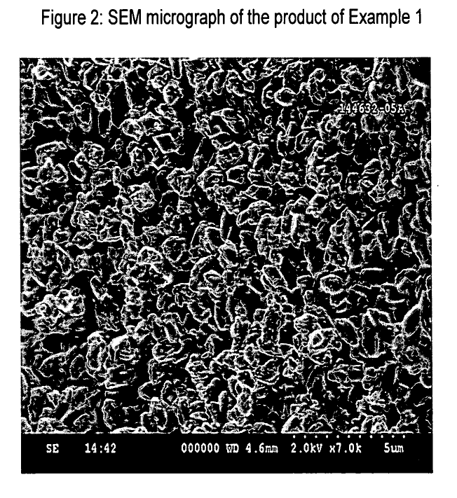

The resulting mixture of solid was transferred to Teflon® lined 5 ml autoclave and crystallized at 180° C. for 65 hours under slow rotation (about 60 rpm). After this time, the resultant solid was recovered by centrifuging, washed with distilled water and dried at 100° C. to give about 293 mg of white microcrystalline solid (27.2% of yield based on the weight of the dry gel). As can be seen from FIG. 1, XRD analysis on as-synthesized material indicated an X-ray diffraction pattern associated with DDR framework topology. An SEM picture of the product is shown in FIG. 2 and indicates a rhombohedral crystal morphology having about 1 micron size.

### EXAMPLE 2

The procedure of Example 1 was repeated but with the crystallization being conducted at 140° C. for 6 days. Again a DDR framework-type material was produced with the average diameter of the crystals being between 1 and 1.5 microns (see FIG. 2).

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A crystalline material having a DDR framework type, wherein said material, in its calcined, anhydrous form, has a composition involving the molar relationship:
(n)X₂O₃:YO₂,
wherein X is a trivalent element, Y is a tetravalent element and n is from 0 to less than 0.01 and wherein the crystals of said material have an average diameter less than or equal to 2 microns.

2. The crystalline material of claim 1, wherein X is aluminum, boron, iron, indium, gallium, or a combination thereof and Y is silicon, tin, titanium, germanium, or a combination thereof.

3. The crystalline material of claim 1, wherein X is aluminum and Y is silicon.

4. The crystalline material of claim 1, wherein n is from about 0.0005 to about 0.007.

5. The crystalline material of claim 1, wherein said material, in its calcined form, contains from about 1 to about 100 ppm by weight of a halide.

6. The crystalline material of claim 1, wherein said material, in its calcined form, contains from about 5 to about 50 ppm by weight of a halide.

7. The crystalline material of claim 1, wherein said material, in its calcined form, contains from about 10 to about 20 ppm by weight of a halide.

8. The crystalline material of claim 5, wherein said halide comprises fluoride.

9. The crystalline material of claim 1, wherein the crystals of said material have an average diameter of about 1 to 1.5 microns.

10. A crystalline material having a DDR framework type, wherein said material, in its as-synthesized form, has a composition involving the molar relationship:
(n)X₂O₃:YO₂:(m)R:(x)F:z H₂O,
wherein X is a trivalent element, Y is a tetravalent element, n is from 0 to less than 0.01, m is from about 0.01 to about 2, such as from about 0.1 to about 1, x is from about 0 to about 2, such as from about 0.01 to about 1, z is from about 0.5 to about 100, such as from about 2 to about 20, and R is at least one organic cation having the formula: 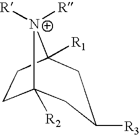
wherein one of R′ and R″ is methyl and the other R′ and R″ is ethyl, R₁ and R₂ are each independently hydrogen or C₁ to C₁₀ alkyl, and R₃ is hydrogen, hydroxyl or C₁ to C₁₀ alkyl.

11. The crystalline material of claim 10, wherein X is aluminum and Y is silicon.

12. The crystalline material of claim 10, wherein m is from about 0.1 to about 1, x is from about 0.01 to about 1, and z is from about 2 to about 20.

13. The crystalline material of claim 10, wherein each of R₁, R₂ and R₃ is hydrogen.

14. A method of synthesizing a crystalline material having a DDR framework-type, the method comprising:
a) forming a reaction mixture capable of forming said crystalline material having a DDR framework-type, wherein the reaction mixture comprises an organic directing agent having the formula: 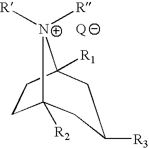
wherein one of R′ and R″ is methyl and the other R′ and R″ is ethyl, R₁ and R₂ are each independently hydrogen or C₁ to C₁₀ alkyl and R₃ is hydrogen, hydroxyl or C₁ to C₁₀ alkyl; and Q⁻ is an anion.
b) recovering from said reaction mixture said crystalline material comprising a DDR framework-type.

15. The method of claim 14, wherein said reaction mixture comprises from about 0.01 ppm by weight to about 10,000 ppm by weight of seeds.

16. The method of claim 14, wherein each of R₁, R₂ and R₃ is hydrogen.

17. The method of claim 14, wherein said reaction mixture also comprises a halide or a halide-containing compound.

18. The method of claim 14, wherein said reaction mixture also comprises a fluoride or fluoride-containing compound.

19. A method of synthesizing a crystalline material having a DDR framework-type and having, in its calcined and anhydrous form, a composition involving the molar relationship:
(n)X₂O₃:YO₂,
wherein X is a trivalent element; Y is a tetravalent element, and n is from 0 to less than 0.01, the method comprising:
(a) preparing a reaction mixture capable of forming said crystalline material having a DDR framework-type, said reaction mixture comprising a source of water, a source of an oxide of the tetravalent element Y, optionally a source of an oxide of the trivalent element X, an organic directing agent for directing the formation of said crystalline material and having the formula: 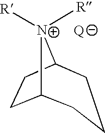
wherein one of R′ and R″ is methyl and the other R′ and R″ is ethyl and Q⁻ is an anion;
(b) maintaining said reaction mixture under conditions sufficient to form crystals of said crystalline material having a DDR framework-type; and
(c) recovering said crystalline material from (b).

20. The method of claim 19, wherein X is aluminum and Y is silicon.

21. The method of claim 19, wherein said reaction mixture comprises from about 0.01 ppm by weight to about 10,000 ppm by weight of seeds.

22. The method of claim 21, wherein said seeds comprise a crystalline material having an AEI, DDR, LEV, CHA, ERI, AFX, or OFF framework-type.

23. The method of claim 19, wherein said reaction mixture also comprises a halide or a halide-containing compound.

24. The method of claim 19, wherein said reaction mixture also comprises a fluoride or fluoride-containing compound.

25. The method of claim 19, wherein said reaction mixture has the following molar composition:

| | |
|---|---|
| H₂O/YO₂ | 2 to 15, |
| Halide/YO₂ | 0.1 to 1.0, |
| R/YO₂ | 0.1 to 1.0, and |
| X₂O₃/YO₂ | 0 to 0.02, |

where R is said organic directing agent.

26. A process for producing olefins comprising contacting an organic oxygenate compound under oxygenate conversion conditions with a catalyst comprising the crystalline material of claim 1.

27. A process for separating methane from carbon dioxide in a gas mixture containing the same, the process comprising contacting passing said gas mixture through a membrane comprising the crystalline material of claim 1.
